(19) United States
(12) Patent Application Publication
(10) Pub. No.: US 2002/0046350 A1
(43) Pub. Date: Apr. 18, 2002

(54) Method and system for establishing an audit trail to protect objects distributed over a network

(76) Inventors: David A. Lordemann, Los Altos, CA (US); Daniel J. Robinson, Santa Clara, CA (US); Paul O. Scheibe, Woodside, CA (US)

Correspondence Address: LAW OFFICE OF THOMAS SCHNECK, P.O. BOX 2-E, SAN JOSE, CA, 95109-0005, US

(21) Appl. No.: 09/952,696

(22) Filed: Sep. 14, 2001

Related U.S. Application Data
(60) Provisional application No. 60/232,599, filed on Sep. 14, 2000.
(60) Provisional application No. 60/233,054, filed on Sep. 15, 2000.

(51) Int. Cl. G06F 11/30; H04L 9/00

(52) U.S. Cl. 713/201

(57) ABSTRACT

A system and method for establishing a log file which may be used to create an audit trail are presented. A security server maintains a log file of actions performed by a requester and the security server which are related to protected objects. Object controls instantiated with the object on the requester device transmit an encrypted descriptor of the action to the security server and may prevent the requester device from taking any action (viewing, editing, printing, etc.) if there is no secure connection to the security server. The security server will record the information received from the requester device, along with other data, to the log file as well as recording a descriptor of any of the security server's actions taken which relate to the protection of objects.

### CROSS-REFERENCE TO RELATED APPLICATION

This application claims priority from U.S. Provisional Application No. 60/232,599, filed Sep. 14, 2000, and U.S. Provisional Application No. 60/233,054, filed Sep. 15, 2000. This application is a continuation-in-part of application Ser. No. ______, filed Sep. 13, 2001, entitled “Method and System for Protecting Objects Distributed Over a Network”.

### FIELD OF THE INVENTION

This invention is related to establishing an audit trail to protect objects such as code, documents, and images that are distributed over a network.

### BACKGROUND OF THE INVENTION

The Internet is now commonly used in the course of business to search for information and exchange code, documents, images, etc. among collaborators, prospective business partners, and customers. The increase in business conducted on the Internet has been accompanied by an increasing concern about protecting information stored or communicated on the Internet from “hackers” who can gain unauthorized access to this information and either use it for their own financial benefit or compromise the information or the system on which it is stored. Given the enormous volume of business conducted on the Internet and the corresponding value of that business, it is imperative that the objects (including code, documents and images—anything represented in digital form) that are stored and exchanged and the intellectual property contained within those objects are secure—i.e., they cannot be accessed by individuals or companies who have no right to them, they cannot be printed unless there is permission to do so, they cannot be edited except where that right has been conferred by the owner.

Protection of objects and object exchanges may have many components. One of these, authentication, is the process of verifying the identity of a party requesting or sending information. This is generally accomplished through the use of passwords. A drawback to this approach is that passwords can be lost, revealed, or stolen.

A stricter authentication process uses digital certificates authorized by a certificate authority. A digital certificate contains the owner's name, serial number, expiration dates, and the digital signature (data appended to a message identifying and authenticating sender and message data using public key encryption (see below)) of the issuing authority. The certificate also contains the certificate owner's public key. In public key cryptography, which is widely used in authentication procedures, individuals have public keys and private keys which are created simultaneously by the certificate authority using an algorithm such as RSA. The public key is published in one or more directories containing the certificates; the private key remains secret. Messages are encrypted using the recipient's public key, which the sender captures in a directory, and decrypted using the recipient's private key. To authenticate a message, a sender can encrypt a message using the sender's private key; the recipient can verify the sender's identity by decrypting the signature with the sender's public key.

Authorization determines whether a user has any privileges (viewing, modifying, etc.) with regard to a resource. For instance, a system administrator can determine which users have access to a system and what privileges each user has within the system (i.e., access to certain files, amount of storage space, etc.). Authorization is usually performed after authentication. In other words, if a user requests access to an object, the system will first verify or authenticate the identity of the user and then determine whether that user has the right to access the object and how that user may use the object.

Encryption may also be used to protect objects. Encryption converts a message's plaintext into ciphertext. In order to render an encrypted object, the recipient must also obtain the correct decryption key (see, for instance, the discussion of the public key infrastructure and public key cryptography above). Although it is sometimes possible to “break” the cipher used to encrypt an object, in general, the more complex the encryption, the harder it is to break the cipher without the decryption key. A “strong” cryptosystem has a large range of possible keys which makes it almost impossible to break the cipher by trying all possible keys. A strong cryptosystem is also immune from previously known methods of code breaking and will appear random to all standard statistical tests.

Other types of security to protect the entire computer system may also be employed at the computer locations. For instance, many businesses set up firewalls in an attempt to prevent unauthorized users from accessing the business' data or programs. However, firewalls can be compromised and do not guarantee that a computer system will be safe from attack. Another problem is that firewalls do not protect the system or the system's resources from being compromised by a hostile user located behind the firewall.

Transmission of messages can also be secured. Transport Layer Security (TLS) and Secure Sockets Layer (SSL) protocols are commonly used to provide encrypted communications between servers and clients. Both these protocols are incorporated into most Web browsers and servers.

Audit trails also provide protection by enforcing accountability, i.e., tracing a user's activities which are either related to an object (such as a request for the object) or actually performed on an object (viewing, editing, printing, etc.). Audit trails must be secure from unauthorized alterations; for instance, unauthorized users cannot be allowed to remove evidence of their activities from an audit log. Auditing requests and actions generates a huge amount of information; therefore, any system generating audit trails must have the capability to store the information and process it efficiently.

The above-mentioned security devices may be used separately, or more commonly, in some combination. In addition to these general devices, there are other approaches to security in the prior art.

InterTrust Technologies Corporation has received several patents related to their digital rights management technology. InterTrust's Digibox container technology enables the encryption and storage of information, including content and rules regarding access to that content, in a Digibox container, essentially a software container. The container, along with the encryption keys, is passed from node to node in a Virtual Distribution Environment (VDE). The VDE consists of dedicated hardware or software or combination thereof. Information in the containers may only be viewed by devices incorporated in a VDE which run the appropriate Intertrust software. An audit trail may be generated, stored, and viewed within the VDE.

There is a need for an invention that will protect objects (basically, anything which may be represented in digital form), including code, documents, images, and software programs, that are available on the Internet without requiring authorized requesters to run special software on their computers in order to access protected information; a secure audit trail to ensure accountability and non-refutability is also desirable. It is also desirable to pass the protection duties, including storing the audit trail, to a third party in order to relieve the object server of both the processing and hardware burden of providing the security (including having enough memory to store a voluminous audit trail). Finally, it would be desirable to store information such as the request, authentication, authorization, serialization of the requested object, nonce of the requested object, security policy of the requested object, and a description of the protected object in the audit trail to provide comprehensive protection and demonstrate the integrity and irrefutability of the audit trail.

There is a need for an invention that will protect objects (basically, anything which may be represented in digital form), including code, documents, images, and software programs, that are available on the Internet without requiring authorized requestors to run special software on their computers in order to access protected information. (For instance, students are often on a limited budget and, even if they have their own computers, cannot reasonably be expected to buy extra software which would enable them to download information like course notes, schedules, etc. that schools are increasingly making available to authorized users over the Internet.) Additional desirable features for a digital rights management system include passing most of the protection “duties” to a third party in order to relieve the object server of the processing burden of providing security and providing one-time encryption keys that are securely passed between the requester and the “security server” rather than passing the encryption keys with the encrypted data. It is also desirable for a digital rights management system to offer protection to an object even after the object has been sent to the requester.

### SUMMARY OF THE INVENTION

This invention provides a method and system for protection of objects (anything represented in digital form, i.e., code, documents, images, software programs, etc.) distributed over a network. Protection denotes restricting certain operations (i.e., viewing, printing, editing, copying) on the objects by certain recipients.

An object server containing objects, both protected and unprotected, is equipped with software that designates whether an object should be protected and, if so, what the security policy (type and degree of protection the object should receive) is. The security policy may include restrictions on who may view the object, the lifetime of the object, the number of times the object may be viewed, as well as actions policies relating to actions such as whether the object may be printed, edited, etc. Object controls are mechanisms which implement the security policy.

When the object server receives a request for an object, the software checks whether the requested object is protected. If the object is unprotected, the server will send the object to the requester. If the object is protected, the software creates a new object which includes authentication and time of the original request as well as serialization, nonce, security policy, and description of the requested object; all of these are encrypted. The new object is sent back to the requesting browser in a reply, along with a redirect command that points the requesting browser to a “security server.”

After the security server, which is equipped with software for providing protection services, receives and authenticates the redirected request, it obtains the requested object either from its own cache or from the server containing the object via a secure transmission. The security server then encrypts the requested object (using strong and non-malleable encryption) and combines it with mobile code (software sent from remote systems, transferred across a network, and downloaded and executed on a local system without explicit installation or execution by the recipient), the security policy, and object controls. This resulting package is sent back to the requesting computer as a reply to the redirected request.

The requesting computer then tries to execute the mobile code in order to render the requested object. The mobile code will execute tests to ensure proper instantiation of the object controls; when these controls are properly instantiated, the requester may request a decryption key which is sent via secure transmission to the requester upon satisfactory authentication of the request. The decryption keys are one-time keys which may be used only for decrypting the specific object in question. If the mobile code executes successfully and a decryption key is obtained, the requested object is rendered subject to the constraints of the security policy and object controls.

A descriptor of any actions involving the security server and the requestor's activities with regard to the object is recorded in a log file available for review by authorized individuals such as the security server's system administrator and the content owner. This log file may be used to construct an audit trail detailing who requested which objects, whether the objects were delivered, what type of security policy was in place for each of these objects and any actions taken on the object by the requester, as well as derived information such as the time an object was accessed, the number of times an object was accessed, etc.

The security server is used to execute most of the activities associated with protecting and delivering the requested object. Therefore, the object server is not spending processing resources on security issues and instead is dedicated to handling requests for information. In addition, all set-up time and maintenance for the security server is handled by that server's system administrators, resulting in further savings to the owners of the object servers.

This method and system differ from other object protection methods and systems in that common software does not need to be installed on all computers involved in the request and provision of a requested object. In addition, the keys used to encrypt/decrypt the object are one-time keys and are not passed with the encrypted object.

### BRIEF DESCRIPTION OF THE DRAWINGS

FIG. 1 is a block diagram of the components of an object protection system in accordance with the invention.

FIG. 2a is a flow chart showing how an object is protected in accordance with the invention.

FIG. 2b is a flow chart showing how an object is protected in accordance with the invention.

FIG. 3a is a flow chart showing how a log file of requestor's activities on a protected object is created in accordance with the invention.

FIG. 3b is a flow chart showing how a log file of security server activities is created in accordance with the invention.

### DETAILED DESCRIPTION

A related application by Lordemann et al., Ser. No. ______ , filed Sep. 13, 2001 is hereby incorporated by reference.

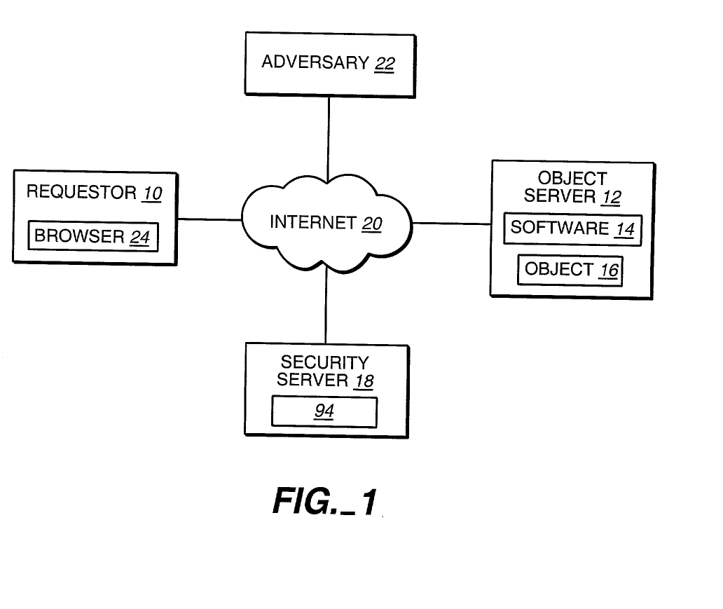

With reference to FIG. 1, a requester device 10 (in this embodiment, the device is a computer; however, the device includes anything that can act as a client in a client/server relationship), an object server 12, containing objects 16 and protection software 14 which designates whether objects are to be protected, and a security server 18 containing software 94 for providing protection services are all connected to a network, in this embodiment, the Internet 20. An object 16 includes anything which may be represented in digital form, such as code, a document, an image, a software program, etc. An adversary 22, a person or device such as a computer or recorder which may be used to gain unauthorized access to a protected object, may also be present. Although a single requestor device 10, object server 12, and security server 18 are discussed here, it is envisioned that this method and system will accommodate a plurality of requester devices 10, object servers 12, and security servers 18.

In this embodiment, the object server 12 and the security server 18 are Hypertext Transfer Protocol (http) servers. The requester device 10 should be running a software program acting as a World Wide Web browser 24. Requests for objects 16 from the requestor device 10 are relayed by the browser 24 to the object server 12 via http requests. Similarly, replies to requests conform to the http protocol.

As noted above, the object server 12 is running protection software 14, which in this embodiment is an extension of http server software. This protection software 14 is used by an authorized system administrator to designate which objects 16 are unprotected and which are to be protected. If an object 16 is designated as protected, the protection software 14 also allows the administrator to specify the type and degree of protection (i.e., the security policy) for the object 16. The security policy may include restrictions on who may view the object, the lifetime of the object (i.e., temporal restrictions), the number of times the object may be viewed (i.e., cardinal restrictions), as well as actions policies relating to whether the object may be printed, edited, etc. The actions that the requester may perform on an object may vary depending on the identity of the requester. Object controls are mechanisms which implement the security policy.

The security server 18 is also running software 94 which is an extension of http server software. This software 94 provides the protection services for objects.

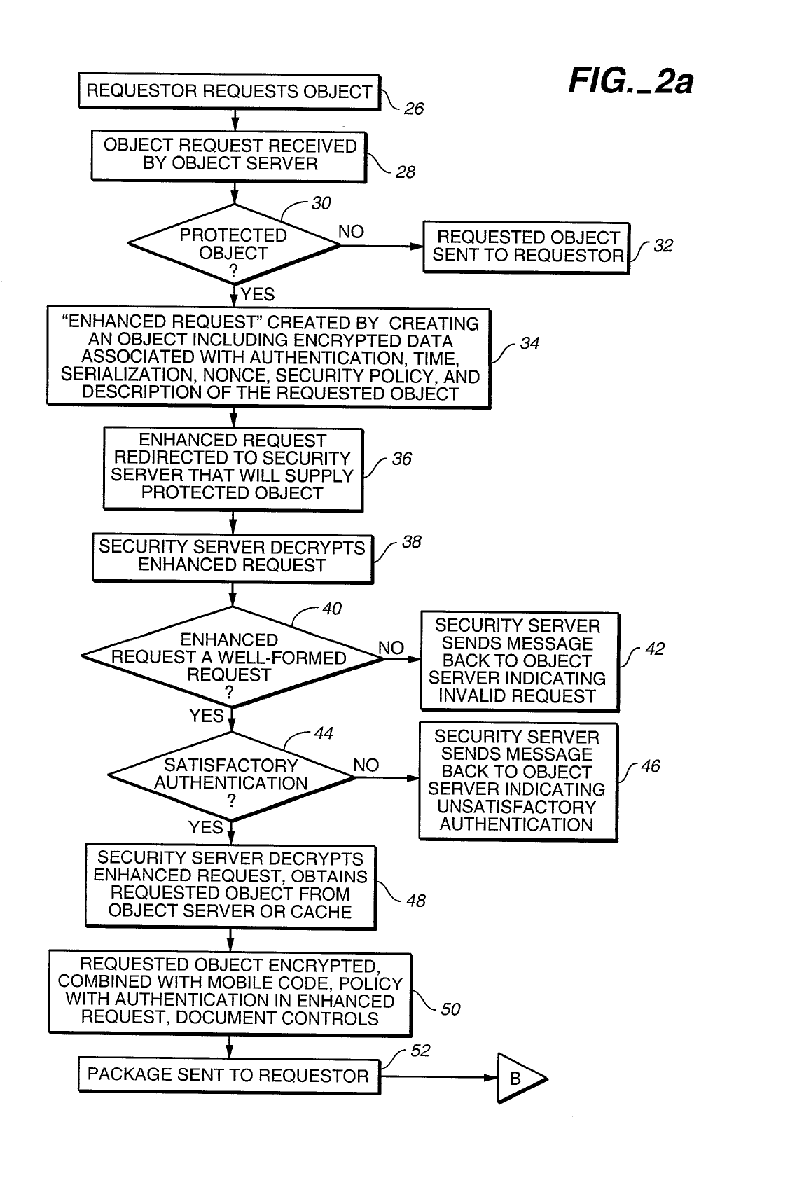

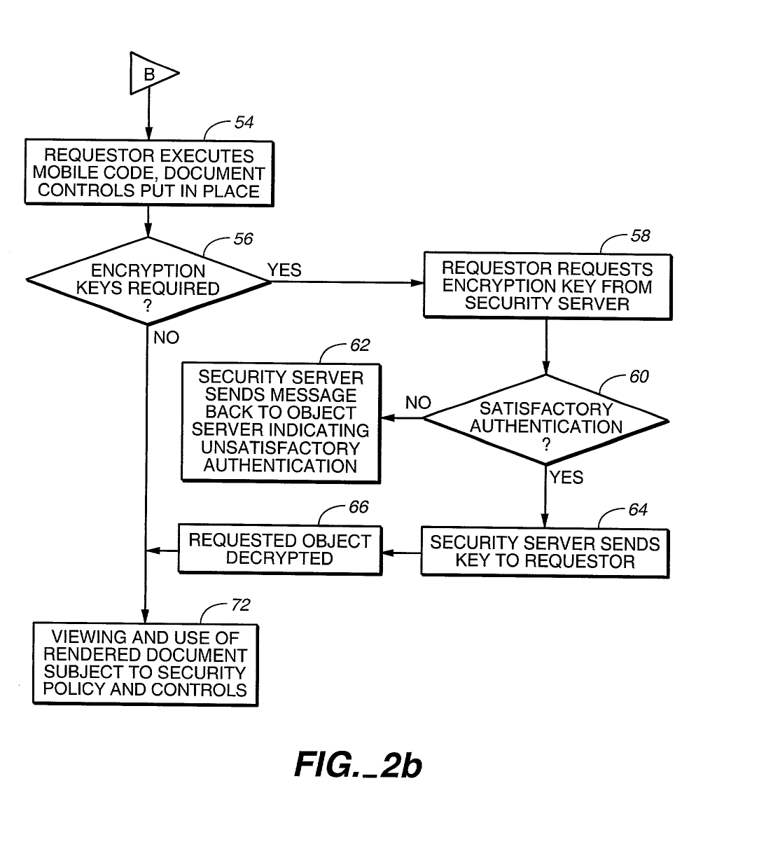

In FIG. 2a, a requestor requests an object (step 26). The object server storing the requested object receives the request (step 28). If the object server has an independent authentication policy, the object server will execute that policy and authenticate the request upon receipt. The protection software examines the http request to determine whether the request is for a protected object (step 30). If the requested object is not protected, the requested object is sent to the requester (step 32).

However, if the object is protected (step 30), the protection software creates an enhanced request (step 34) that is included in a reply to the request and is subsequently redirected to the security server (step 36). The enhanced request is an object comprising encrypted data including authentication and time of the original request as well as serialization (ensuring only one approved version of an object is available), nonce, security policy, and a description of the requested object. (Information about authentication depends on whether the object server has an independent authentication policy. If there is an authentication policy, the enhanced request includes the result of the authentication. If there is no authentication policy, that information is also included in the enhanced request.)

Encryption provides a variety of services. It can protect the integrity of a file (i.e., prevent unauthorized alterations) as well as assisting with the authentication and authorization of a request. The use of encryption here can also protect the privacy of the requester. Other uses for encryption include non-repudiation and detecting alterations. Protocols supporting both strong and non-malleable encryption are used. (Protocols determine the type of encryption used and whether any exchanges between the requestor and security server are necessary before encryption takes place (for example, a key many need to be exchanged so the recipient can decrypt an object encrypted at the server).)

The enhanced request is included in the reply to the requester along with a command to redirect the request to the security server. This redirection should be transparent to the requester.

The security server software decrypts the enhanced request (step 38). A shared key for encrypting/ decrypting the enhanced request is present at the object server and the security server. The key is generated when the software is installed on the object server.

The security server software then checks whether the enhanced request meets the requirements for a well-formed request (step 40). If the requirements for a well-formed request are not met, the security server sends a message back to the object server indicating an invalid request (step 42). (The object server may then send a message to the requestor about the invalid request. The system administrator for the object server determines whether these messages will be sent.)

If the request is valid, the security server software next authenticates the request (step 44). The security server software will compare the time and authentication in the redirected request heading with those contained in the enhanced request. If the security server software cannot authenticate the request (for instance, the two request times differ such that a replay attack is indicated or the identity of the requester in the redirected request differs from the identity of the requester in the enhanced request), a message is sent back to the object server indicating unsatisfactory authentication (step 46). If the request is authenticated, the security server software decrypts the request and obtains the requested object either from the security server's cache or the object server (step 48). (The protection software will pass the object on to the security server upon request.) If the security server has to obtain the object from the object server, the object is passed via a secure transmission.

Once the security server has the requested object, the security server software encrypts it using protocols for strong encryption and non-malleable encryption and combines the object with mobile code (software sent from remote systems, transferred across a network, and downloaded and executed on a local system without explicit installation or execution by the recipient), a security policy with authentication contained in the enhanced request, and object controls (step 50). Encryption of the requested protected object serves to protect the object, its requester, and the provider by ensuring integrity, privacy, authentication (where appropriate), and authorization as well as being a tool for non-repudiation (i.e., a party to a transaction cannot falsely deny involvement in that transaction) and detecting alterations. The resulting package is then sent to the requestor (step 52; see step B, FIG. 2b).

In FIG. 2b, the requester receives the reply and attempts to execute the mobile code (step 54). Upon execution of the mobile code, the security policy and object controls for the requested object are instantiated on the requestor's computer (step 54). The mobile code executes tests to determine whether the object controls were correctly instantiated. If so, if the requestor needs a decryption key (step 56), the requester may request it from the security server (step 58). The security server software authenticates the request (step 60). If it cannot authenticate the request, a message to that effect is sent to the object server (step 62). However, if the message is authenticated, the security server software sends the requested key back to the requester (step 64) via a secure transmission, and the requested object is decrypted (step 66). The key used by the security server to encrypt/decrypt the object is a one-time key. The one-time key is provided either by a ”seed” for randomly generating the key which is determined at the installation of security server software or other means known in the prior art, the most common being certificates.

Once the mobile code is executed, the requester may view the object subject to any constraints imposed on the object by the security policy or object controls (step 68).

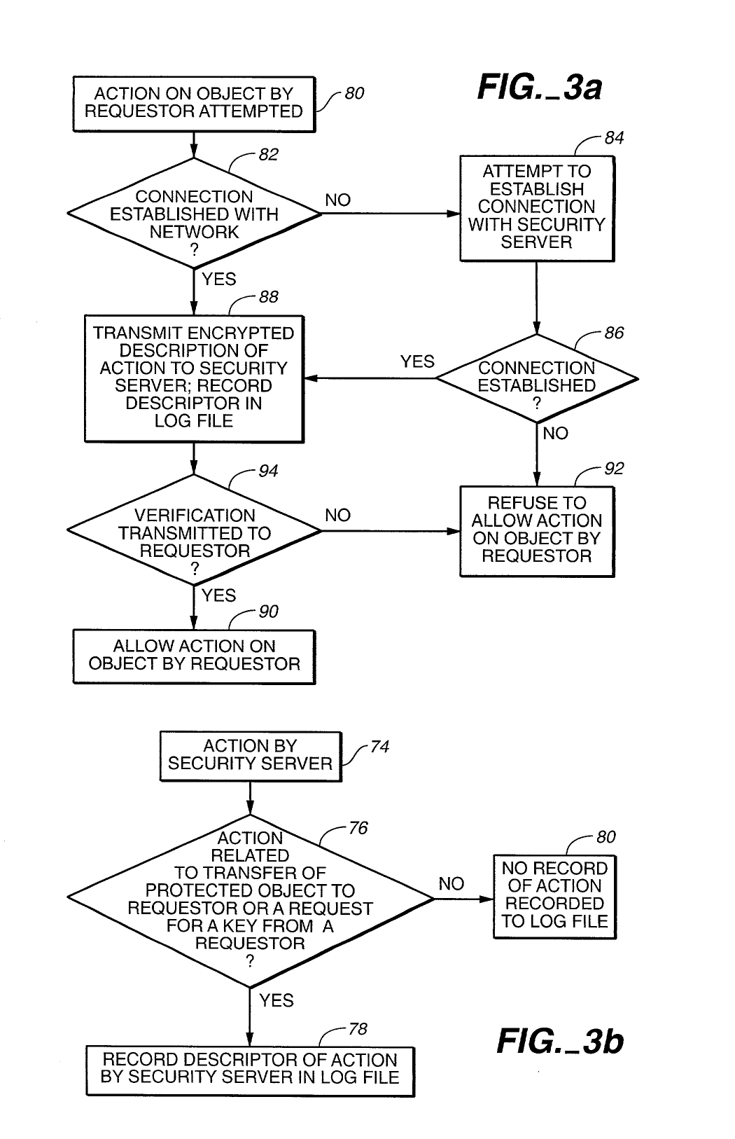

As shown in FIG. 3a, a log file of actions taken on the object by the requester (and, as will be shown in FIG. 3b, actions taken by the security server) is maintained for the purpose of establishing an audit trail. The log file is available for review by the security server's system administrator. The log file may be used to construct an audit trail detailing who requested what objects, whether the objects were delivered, and what type of security policy was in place for each of these objects.

If the requester attempts any action related to the object (i.e., viewing, printing, editing the object, etc.) (step 80), the object controls will determine whether there is an established connection to a network (step 82). If there is an open connection, an encrypted descriptor of the action will be transmitted to the security server, which will record the descriptor along with some other data in a log file (step 88). The other material recorded to the log file also includes “local data,” i.e., data present at the server including the local time and the identity of the server, time, and the requestor's network IP address. Once the information is transmitted to the security server and verification is transmitted to the requester (step 94), the action on the object is allowed (step 90). For instance, as discussed above, the requester may view the requested object only when the mobile code is successfully instantiated and a decryption key has been received from the security server. When the object is first viewed at the requestor's computer, a descriptor of this event, i.e., viewing the object, is sent to the security server. If no verification is transmitted to the requester (step 94), the requestor's request to perform an action on the object is denied (step 92).

If no secure established connection to the security server is present, the object controls will attempt to establish such a connection to the security server (step 84). If the connection is established (step 86), an encrypted descriptor of the action will be transmitted to the security server, which will record the descriptor and the other data discussed above in a log file (step 88). The action on the object is then allowed (step 90). However, if a connection cannot be established (step 86), the requestor's request to perform an action on the object is denied (step 92).

As shown in FIG. 3b, the security server also records to a log file descriptors of any actions it takes with regard to a protected object. These actions include responding to requests for objects, sending the object to the requester, receiving requests for decryption keys, and sending a decryption key to the requester. When the security server performs an action (step 74), system software determines whether that action is related to the transfer of a protected object or a request for a decryption key (step 76). If the action is not related to the transfer of a protected object or a request for a decryption key, nothing is recorded to the log file (step 80). However, when the action is related to either a protected object or a decryption key, a descriptor of the action, along with time, local data, and the network IP address of the requestor, is recorded to a log file (step 78). As an example, when the security server receives an enhanced request for a protected object, the security server saves the enhanced request to the log file; along with the enhanced request, at least time, local data, and the network IP address of the requester are saved. When the security server sends the requester a package containing the object combined with mobile code, a record of this action is written to the log file.

In another embodiment, the requestor may take actions on the object while “untethered” (i.e., not connected to the security server). Provided the security policy allows untethered activity, the requestor's actions are recorded on the requester device and then sent to the security server when the requestor establishes a connection to the security server. Controls may be set such that access to the object is restricted if a connection to a network is not established within a set time frame.

In another embodiment, the descriptors of the security server's actions may be encrypted before they are written to the log file. This embodiment may be used when persons other than the system administrator are allowed access to the log file.

1. In a communications network, a method for providing and protecting a record of requested actions and actions taken on objects distributed on a network, said method comprising:
a) recording to a log file information about events, said log file stored on a security server, said events belonging to the group consisting of:
i) requests for action on a requested protected object initiated by a requester device;
ii) action taken on the requested protected object at the requestor device; and
iii) actions taken by the security server, said actions related to the protection of the requested protected object; and
b) providing an authorized user access to the log file.

2. The method of claim 1 further including object controls instantiated on the requestor device denying an attempted action on a protected object at the requestor device when the requestor device is not in network communication with the security server.

3. The method of claim 1 further including object controls instantiated on the requestor device attempting to establish a connection between the requestor device and the security server when the requestor device is not in network communication with the security server and the requester device attempts an action on the protected object.

4. The method of claim 1 wherein the information recorded to the log file includes local data.

5. The method of claim 1 wherein the information recorded to the log file includes time of the event.

6. The method of claim 1 wherein the information recorded to the log file includes a network IP address of the requester device initiating the event.

7. The method of claim 1 wherein the information recorded to the log file includes a descriptor of the event.

8. The method of claim 1 wherein the information recorded to the log file includes a request sent to the security server.

9. The method of claim 1 wherein the information sent by the requestor device to the security server is encrypted according to a protocol.

10. The method of claim 9 wherein a protocol including encryption for the information provides strong encryption.

11. The method of claim 9 wherein a protocol including encryption for the information provides non-malleable encryption.

12. The method of claim 1 wherein the log file is used to create an audit trail.

13. The method of claim 1 wherein an untethered requester device records any actions on a protected object in a file on the requestor device and sends the file to the security server when the requester devices establishes a network connection to the security server.

14. The method of claim 1 wherein access to the log file includes restricted views of the log file.

15. In a communications network, a system for protecting objects by providing a log file of requested actions and actions taken on objects distributed in a network, said system comprising:
a) an object server containing objects, said object server running a software program which designates what objects are to be protected and a security policy for protected objects, said object server connected to a network;
b) a requester device requesting an object from the object server, said device connected to the network; and
c) a security server running another software program providing protection services for objects designated by the software program as protected, said security server connected to the network, said software providing protection services including:
i) means for receiving a redirected, enhanced request for the requested object from the requestor device, said enhanced request corresponding to the requester device's original request and created by the object server, said enhanced request an object including encrypted data associated with authentication and time of the original request as well as serialization, nonce, security policy, and description of the requested object;
ii) means for obtaining said requested protected object from a cache or from the object server on which the requested protected object is stored;
iii) means for encrypting said requested protected object;
iv) means for combining the requested protected object with mobile code, a security policy, and object controls; and
v) means for sending the resulting file to the requesting device, said requesting device having to execute the mobile code to render the requested object to the requesting device, a user of the requesting device to use and view the object subject to the security policy and object controls that are put in place on the requesting device upon execution of the mobile code;
vi) means for verifying proper instantiation of the object controls;
vii) means for providing a decryption key to the requesting device upon satisfactory authentication of a request for said key; and
viii) means for recording to a log file information about events, said log file stored on the security server, said events belonging to the group consisting of:
A) requests for action on a requested protected object initiated by the requestor device;
B) action taken on a requested protected object at the requester device; and
C) actions taken by the security server, said actions related to the protection of the requested protected object.

16. The system of claim 15 wherein the log file is used to create an audit trail.

17. The system of claim 15 wherein the information recorded is time of the event.

18. The system of claim 15 wherein the information recorded is local data.

19. The system of claim 15 wherein the information recorded is a network IP address of the requestor device initiating the event.

20. The system of claim 15 wherein the information recorded to the log file includes a descriptor of the event.

21. The system of claim 15 wherein the information recorded to the log file includes a request sent to the security server.

22. The system of claim 15 wherein the information sent by the requestor device to the security server is encrypted according to a protocol.

23. The system of claim 22 wherein a protocol including encryption for the information provides strong encryption.

24. The system of claim 22 wherein a protocol including encryption for the information provides non-malleable encryption.

25. The system of claim 15 further including means to establish a connection between the requestor device and the security server in order to record information about requests for action initiated at the requester device, said connection to be established when there is no existing connection between said requester device and said security server.

26. The system of claim 25 further including means to refuse a requested action on a protected object if a connection between the requester device and the security server cannot be established.

27. The system of claim 15 further including means for an untethered requestor device to record any actions on a requested protected object in a file on the requestor device and send the file to the security server when the requestor devices establishes a network connection to the security server.

28. In a communications network, a system for protecting objects by creating a log file of requested actions and actions taken on objects distributed in a network, said system comprising:
a) a requestor device connected to a network; and
b) a security server providing protection services for objects, said server connected to a network, s aid security server having means for recording to a log file stored on the security server information about events belonging to the group consisting of:
i) requests f or action on a protected object instantiated at the requestor device, said request communicated from the requestor device to the security server;
ii) actions taken on a protected object instantiated at the requestor device; and
iii) actions taken by the security server, said actions related to the protection of the requested protected object.

29. The system of claim 28 wherein the log file is used to create an audit trail.

30. The system of claim 28 wherein the information recorded is time of the event.

31. The system of claim 28 wherein the information recorded is local data.

32. The system of claim 28 wherein the information recorded is a network IP address of the requestor device initiating the event.

33. The system of claim 28 wherein the information recorded to the log file includes a descriptor of the event.

34. The system of claim 28 wherein the information recorded to the log file includes a request sent to the security server.

35. The system of claim 28 wherein the information sent by the requester device to the security server is encrypted according to a protocol.

36. The system of claim 35 wherein a protocol including encryption for the information provides strong encryption.

37. The system of claim 35 wherein a protocol including encryption for the information provides non-malleable encryption.

38. The system of claim 28 further including means to establish a connection between the requester device and the security server in order to record information about requests for action initiated at the requester device, said connection to be established when there is no existing connection between said requestor device and said security server.

39. The system of claim 38 further including means to refuse a requested action on a protected object if a connection between the requestor device and the security server cannot be established.

40. In a communications network, a system for protecting objects by creating a log file of requested actions and actions taken on objects distributed in a network, said system comprising:
a) a requestor device containing a protected object distributed by a security server, said object's security policy allowing actions on the object when the requestor device is not connected to a network;
b) a security server providing protection services for objects, said security server connected to a network, said security server having means for recording to a log file stored on the security server information about events belonging to the group consisting of:
i) actions taken on a protected object instantiated at the requester device; and
ii) actions taken by the security server, said actions related to the protection of the protected object;
wherein the untethered requester device has means for recording information about actions taken on the protected object in a file on the requester device and sending the file to the security server when the requester device establishes a network connection to the security server.

41. The system of claim 40 wherein the log file is used to create an audit trail.

42. The system of claim 40 wherein the information recorded is time of the event.

43. The system of claim 40 wherein the information recorded is local data.

44. The system of claim 40 wherein the information recorded is a network IP address of the requestor device initiating the event.

45. The system of claim 40 wherein the information recorded is a descriptor of the event.

46. The system of claim 40 wherein the information sent by the requestor device to the security server is encrypted according to a protocol.

47. The system of claim 46 wherein a protocol including encryption for the information provides strong encryption.

48. The system of claim 46 wherein a protocol including encryption for the information provides non-malleable encryption.
